(19) United States
(12) Patent Application Publication
(10) Pub. No.: US 2013/0198773 A1
(43) Pub. Date: Aug. 1, 2013

(54) SYSTEM AND METHOD OF AUGMENTING LINEAR BROADCAST ADVERTISING

(71) Applicants: Brian Jentz, Wiltshire (GB); Steven Michael Cormie, Cambridge (GB); Christopher Forrest Gordon, Los Angeles, CA (US); David John Terry Evans, Monmouthshire (GB); Marcus Christakis Liassides, Highland, UT (US)

(72) Inventors: Brian Jentz, Wiltshire (GB); Steven Michael Cormie, Cambridge (GB); Christopher Forrest Gordon, Los Angeles, CA (US); David John Terry Evans, Monmouthshire (GB); Marcus Christakis Liassides, Highland, UT (US)

(73) Assignee: XUMO LLC, Irvine, CA (US)

(21) Appl. No.: 13/751,884

(22) Filed: Jan. 28, 2013

Related U.S. Application Data
(60) Provisional application No. 61/591,336, filed on Jan. 27, 2012.

(51) Int. Cl. H04N 21/43

(52) U.S. Cl. CPC H04N 21/43
USPC 725/32

(57) ABSTRACT

A system, method, and apparatus provide the ability to augment advertisements in a linear broadcast stream. A device playing video and/or audio broadcast as a linear stream detects the start of an advertisement that has been provisioned with augmented functionality. The device then retrieves the augmentation/augmented functionality and presents the augmentation during broadcast of the advertisement.

### CROSS-REFERENCE TO RELATED APPLICATIONS

This application claims the benefit under 35 U.S.C. Section 119(e) of the following co-pending and commonly-assigned U.S. provisional patent application(s), which is/are incorporated by reference herein:

Provisional Application Ser. No. 61/591,336, filed on Jan. 27, 2012, by Brian Jentz, Steve Cormie, Chris Gordon, Dai Evans, and Marcus Liassides, entitled “System and Method of Augmenting Linear Broadcast Advertising,” attorneys' docket number 257.41-US-P1.

### BACKGROUND OF THE INVENTION

1. Field of the Invention

This invention relates generally to augmenting linear broadcast advertising. More particularly, this invention relates to methods and systems for providing augmented functionality to one or more advertisements being played as a linear stream.

2. Description of the Related Art

Advertisers pay broadcasters to place advertisements (ads) into regular slots in a linear broadcast TV channel. These ads are typically, but not always, around thirty (30) seconds long and are typically grouped together in a slot that lasts a few minutes. Once an ad has been incorporated into the linear broadcast stream the advertiser must simply rely on a reasonable number of people viewing the ad and some proportion of those that viewed the ad performing some follow up action. The advertiser has no way of knowing how many people viewed the ad or whether anyone did anything to follow up.

Accordingly, there is a need in the art for an improved system and method for providing augmented features for improving the effectiveness of linear broadcast advertising.

### SUMMARY OF THE INVENTION

The above-described and other problems and disadvantages of the prior art are overcome and alleviated by the present system and method of augmenting advertisements provided in linear broadcast streams.

In exemplary embodiments, a system and method is described that configures a device that is playing video and/or audio broadcast as a linear stream to detect the start of an advertisement that has been provisioned with augmented functionality separately from the broadcast linear stream and to trigger said augmented functionality.

The augmented functionality may be retrieved separately from or part of the linear broadcast stream. For example, the augmented functionality/augmentation may be retrieved from a server separately from the linear broadcast stream. Alternatively, the augmented functionality/augmentation may be broadcast from a broadcast center with the linear broadcast stream and stored locally for subsequent retrieval (e.g., upon detection of an advertisement associated with the augmentation).

In one exemplary embodiment, a generic marker is placed in an advertisement that is included in a broadcast. The marker enables a device that is playing the broadcast to detect the start of an advertisement that has been provisioned with augmented functionality separately from the broadcast linear stream. Upon detection of the marker, the device retrieves the augmented functionality (e.g., from a server and/or from local storage).

In further exemplary embodiments, the marker is a generic audio marker provided at or near the start of an audio/video advertisement or advertisement portion having augmented functionality. The marker may be configured such that it is not detected under normal listening conditions. Upon detection of the marker, the device may be configured to trigger the augmented functionality for display over, along with or separately from the linear broadcast.

In further exemplary embodiments, the marker is a generic video marker provided at or near the start of an audio/video advertisement or advertisement portion having augmented functionality. The marker may be configured such that it is not detected under normal viewing conditions. Upon detection of the marker, the device may be configured to trigger the augmented functionality for display over, along with, or separately from the linear broadcast.

In further exemplary embodiments, there is neither an audio or video marker incorporated into an audio/video advertisement and the advertisement having augmented functionality is detected by continuously taking fingerprints of the audio/video stream in order to find a match to one of a number of possible advertisements. Upon matching a fingerprint to an advertisement having augmented functionality, the device may be configured to trigger the augmented functionality for display over, along with, or separately from the linear broadcast.

In exemplary embodiments, the device retrieves augmented functionality from an identification server that includes augmented data associated with the advertisement. One exemplary method for associating augmented data to a displayed advertisement is to include a fingerprint of at least a portion of the advertisement (e.g., of the first few seconds) on the identification server and to compare that fingerprint with a fingerprint generated from the broadcast stream by the device playing the broadcast stream. The identification server could then return the appropriate augmented data for playback along with or separate from the broadcast advertisement. A further exemplary method for associating augmented data with a displayed advertisement is to include a fingerprint of at least a portion of the advertisement within a database on the client device and to compare that fingerprint with a fingerprint generated from the broadcast stream by the device playing the broadcast stream. The device could then request the appropriate augmented data from the identification server for playback along with or separate from the broadcast advertisement.

Exemplary augmented functionality includes but is not limited to display of additional graphics and information alongside or overlaid on top of an advertisement; allowing interactivity with a viewer of the advertisement; allowing immediate follow-up by a viewer relative to a displayed advertisement; determining whether an advertisement was viewed entirely; determining if a viewer followed up with an advertisement; causing augmented functionality to be displayed on another device, among others.

The above discussed and other features and advantages of the present invention will be appreciated and understood by those skilled in the art from the following detailed description and drawings.

### BRIEF DESCRIPTION OF THE DRAWINGS

Referring now to the drawings in which like reference numbers represent corresponding parts throughout:

FIG. 1 is an exemplary flow chart illustrating construction of an advertisement using a detectable marker and provision of that advertisement to both a broadcaster and an identification server;

FIG. 2 is an exemplary flowchart illustrating detection of the marker described in FIG. 1 by a viewing device and retrieval of a data package including data regarding an augmentation from an identification server;

FIG. 3 is an exemplary hardware and software environment/platform used to implement one or more embodiments of the invention; and

FIG. 4 illustrates the interaction between different components of a system/platform of embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It will also be understood that the terms “media,” “multi-media,” “video,” or any variation thereof may be interchangeable. Thus any form of media may be applicable to example embodiments.

It should also be understood that other terms used herein may be applicable based upon any associated definition as understood by one of ordinary skill in the art, although other meanings may be applicable depending upon the particular context in which terms are used.

As described herein, example embodiments of the present invention may include a system and method that configures a device that is playing video and/or audio broadcast as a linear stream to detect the start of an advertisement that has been provisioned with augmented functionality separately from the broadcast linear stream and to trigger said augmented functionality.

In exemplary embodiments, a generic marker is placed in an advertisement that is included in a broadcast. The marker enables a device that is playing the broadcast to detect the start of an advertisement that has been provisioned with augmented functionality separately from the broadcast linear stream. Upon detection of the marker, the device retrieves the augmented functionality.

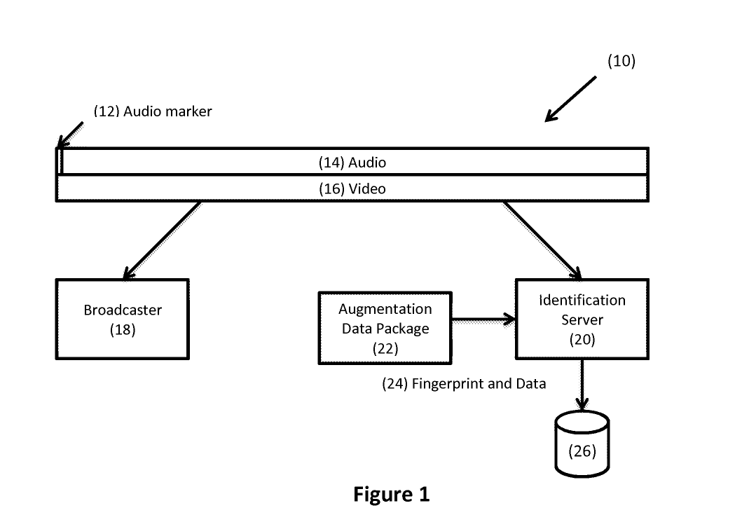

Referring now to FIG. 1, an exemplary audio/video playback system and method is illustrated generally at (10). A marker (12) is provided as a generic audio or video marker at or near the start of an audio/video advertisement or advertisement portion having augmented functionality. In this embodiment, the advertisement comprises an audio portion (14) and a video portion (16). The marker may be configured such that it is not detected under normal listening or viewing conditions. For example, an audio marker (12) may consist of sound in a very low frequency (e.g., below 20 Hz) or a very fast frequency (e.g., above 20,000 Hz). Alternatively, a command may be sent to the audio/video playback system that sets the volume (e.g., for a time period that includes the audio marker (12)) to zero wherein the marker (12) may include a sequence of tones or a particular tone that is not normally played. In yet another embodiment, the maker (12) may consist of a tone that is outside of the range of the advertisement (10) by a defined amount (e.g., 10 Hz beyond the highest/lowest frequency of the advertisement (10)). Upon detection of the marker, the device may be configured to trigger the augmented functionality for display over, along with or separately from the linear broadcast.

Embodiments of the invention are not intended to be limited by any particular method of creating a marker and any type of methodology may be utilized.

The advertisement is then sent to a broadcaster (18) for inclusion into a linear broadcast stream. In exemplary embodiments, and as will be described in more detail below, the advertisement may also be sent to an identification server (20) that has access to an augmentation data package (22) associated with the advertisement. In certain exemplary embodiments, a mechanism for associating a particular advertisement with particular augmented data includes associating the data package with a fingerprint of the advertisement and storing the fingerprint and the data package (24) in storage (26) at or connected to the identification server (20).

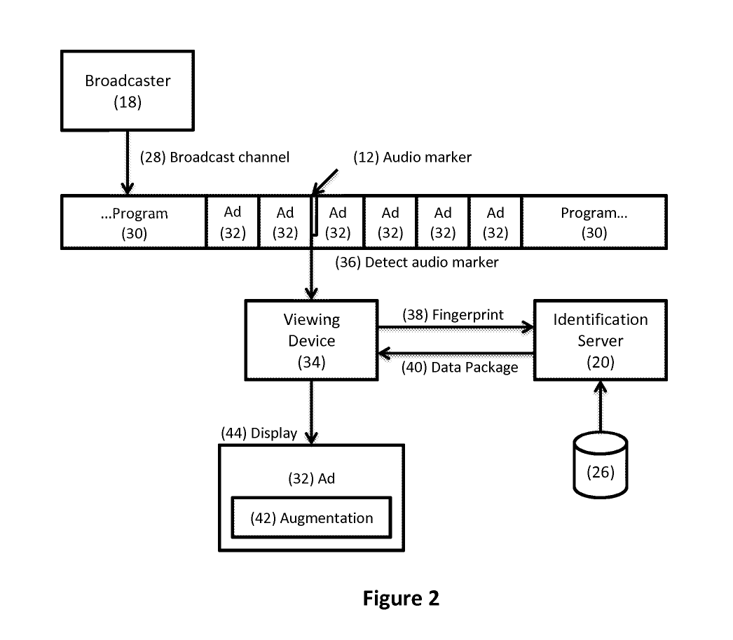

Referring now to FIG. 2, in exemplary embodiments, the broadcaster (18) provides a broadcast channel (28) that includes at least one program (30) and at least one advertisement (32). In this exemplary embodiment, an audio or video marker (12) is provided in at least one advertisement (32) that also is associated with augmented data. In exemplary embodiments, a device, such as a viewing device (32) detects an audio or video marker (see action (36)).

In other exemplary embodiments, there is no audio or video marker included in the advertisement (32) and the viewing device (32) detects the advertisement (32) by continuously taking fingerprints of the broadcast channel (28) and trying to match the fingerprints against a database of possible advertisements.

Referring still to FIG. 2, in exemplary embodiments, the device (34) then retrieves augmented functionality from an identification server (20) that includes augmented data associated with the advertisement from storage (26) associated with the identification server (20). One exemplary method for associating augmented data to a displayed advertisement is to include a fingerprint of at least a portion of the advertisement (e.g., of the first few seconds) on the identification server and to compare that fingerprint with a fingerprint generated from the broadcast stream by the device playing the broadcast stream after the marker is detected. In FIG. 2, the viewing device provides a fingerprint to the identification server at (38), and the identification server returns the appropriate data package to the viewing device at (40). The viewing device (34) may provide an augmentation (42) for playback along with (e.g., on the same display (44)) or separate from the broadcast advertisement (32).

In other exemplary embodiments, the device (34) may compare the fingerprint against a local database and if a match is found, then request the appropriate data package from the identification server at (38) instead of sending the fingerprint, and the identification server returns the appropriate data package to the viewing device at (40). The viewing device (34) may provide an augmentation (42) for playback along with (e.g., on the same display (44)) or separate from the broadcast advertisement (32).

As used herein, the fingerprint consists of a unique set of inherent properties that are identified based on an analysis of the media (e.g., advertisement). A fingerprint does not embed any information in the advertisement (e.g., in contrast with a watermark) but analyzes the audio (14) and video (16) to determine the unique characteristics of the advertisement. As an example, four samples could be taken of the waveform (of the advertisement) every 10^{th} of a second for the audio (14) and video (16). The frequency levels of each sample are stored and may be concatenated together to create a “fingerprint” or digital representation of the advertisement. Accordingly, a fingerprint is usually level based and taken over a period of time. Some fingerprints may use luminance characteristics, while others use transitions, edges, peaks, frequency, motion, and or color characteristics. A fingerprint is generated by looking at these particular characteristics and then using a formula to condense the data down into a small representation (e.g., a numerical value).

A fingerprint may also incorporate metadata about the media (e.g., along with the fingerprint pattern). Such metadata may consist of information about the source/creator of the advertisement, a history of use, which operating system the advertisement has been played on, and by what version of which player technology. Accordingly a fingerprint may consist of a pattern of inherent characteristics representing a specific advertisement.

As an alternative to a fingerprint, embodiments of the invention may also utilize a watermark to identify an advertisement. Such a watermark may add information to the advertisement embedding it within a video and/or audio signal (e.g., increasing the brightness of every 100^{th} pixel by a small amount, or by including very subtle color variations in each frame (or every 10^{th} frame) of an image).

Embodiments of the invention are not intended to be limited by any particular fingerprinting/watermarking technology and any type of methodology may be utilized.

An exemplary method in accordance with the above may begin when an advertisement is created and a generic marker is placed in the audio or video at the beginning of the advertisement, which marker cannot be detected under normal listening or viewing conditions. The advertisement may then be provided to broadcasters to be incorporated into one or more linear broadcast TV channels. The advertisement may also be uploaded to an identification server along with a package of data that implements the augmented functionality.

The identification server may then process the video file and create a series of fingerprints for the advertisement (e.g., by using the first few seconds of the advertisement). The identification server may then store these fingerprints and the associated package of data in a database. The identification server may hold this database locally and may also distribute this database to all client devices.

In further exemplary embodiments, a viewing device continuously scans the linear broadcast stream that is being played looking for a generic marker in the audio or video. When a marker is detected, the device may create a fingerprint from the broadcast stream.

In further exemplary embodiments, a viewing device may not scan the linear broadcast stream looking for a generic marker in the audio or video but instead continuously takes fingerprints of the linear broadcast stream that is being played and attempt to match these against a database of fingerprints of possible advertisements that have associated augmented functionality.

The client device may then compare these fingerprints against a local database distributed by the identification server or may send these fingerprints to the identification server for comparison against the database held by the identification server. If the fingerprint is matched against a database held locally on the device then the device will request the associated package of data that implements the augmented functionality from the identification server. Alternatively, if the database is held in the identification server then the device will send the fingerprint to the identification server for it to be tested against the database. If a match is found, then the identification server may return the associated package of data to the device that implements the augmented functionality. The device may then use the package of data to create the augmented functionality. Further, the device may report statistics on how a viewer responded to the ad and/or augmented functionality. In other words, the device may be configured to record interactions with the augmented functionality. Alternatively, the interaction with the augmented functionality may be recorded on the server side (e.g., by selecting a hyperlink within the augmented functionality, the user may be redirected to a server that is configured to record any further interactions).

Exemplary augmented functionality includes but is not limited to display of additional graphics and information alongside or overlaid on top of an advertisement; allowing interactivity with a viewer of the advertisement; allowing immediate follow-up by a viewer relative to a displayed advertisement; determining whether an advertisement was viewed entirely; determining if a viewer followed up with an advertisement; causing augmented functionality to be displayed on another device (e.g., a tablet, smartphone, or other thin client device), among others. Without limitation, any kind of augmentation may be made relative to the advertisement, including augmentations that are designed to make a product or service more compelling, or augmentations that allow users to take immediate actions if interested in the product or service.

Further, the system may be configured such that advertisers or others can obtain statistics on a number of viewers that left an advertisement by changing channels, a number of viewers that interacted with augmented functionality/augmentation, and numbers of viewers that took positive or negative action. Any kind/type of such analytics is contemplated herein. Such statistics may be recorded either on the client side (e.g., via the viewing device or media player) or on the server side (e.g., via the identification server (20) or server that created/delivered the advertisement/augmented functionality).

### Hardware Environment

As used herein, “media content” refers to audio, audio-video, video, images, and/or any other content that can be viewed on a display device. As described above, a variety of different hardware platforms/systems may be utilized to deliver and view advertisements and augmentation data. Embodiments of the invention are intended to apply to all and/or a subset of such platforms/systems. Several exemplary platforms/systems are described herein but the invention is not limited to such platforms/systems.

It may be useful to note that as used herein, the hardware platform/system includes several components: (1) the screen/monitor/display on which media content/advertisement/augmentation data is viewed (referred to as “display device”); (2) the hardware that receives the media content from a source and formats/delivers the content to the display device (referred to as a “media receiver”); and (3) the transmission mechanism/distribution system for the media content. It may also be noted that the functionality performed by each of the components may at times be performed by other components in the hardware platform/system. In addition, the components may be integrated together. For example, the display device may be integrated into and be part of the media receiver.

Embodiments of the invention may be utilized in the context of television viewing but may also apply to any device that is capable of viewing/displaying media content including cellular devices (e.g., cellular phones), personal digital assistants (PDAs), tablet computers (e.g., the iPad™ tablet), music players (e.g., MP3 players such as iPod™ music players), Set-Top-Boxes (STBs), games consoles, etc. In the context of television viewing, the display device may consist of traditional television display devices (e.g., LED [light emitting diode] televisions, plasma televisions, LCD [liquid crystal display], cathode ray tube [CRT] displays). Such traditional display devices may receive the media content directly from a broadcast source (e.g., via an integrated antenna or via cable, wireless network, etc.) wherein the tuner/receiver is integrated into the display device. Alternatively, the display device may be connected to a tuner/media receiver (e.g., a set top box) that receives the content, decodes the content, etc. for display on the display device. Such a set top box (STB) may receive the content via satellite, cable, broadcast, etc.

In one or more embodiments of the invention, the media content may be viewed on a display device that receives the media content via the Internet or broadband connection. In such an embodiment, the display device may be a computer monitor that receives the content from a computer via a user's broadband connection (e.g., to the Internet). Alternatively, the television itself may be “connected” to the Internet such that it is Internet-enabled. In alternative embodiments, the receiver that delivers content to a display device may consist of hardware/media player specifically directed towards television viewing (e.g., via a broadband connection). Examples of such devices include a Boxee device, an AppleTV™ device, a Google™ set-top box, a Roku™ television device, etc. In yet another embodiment, the display device may consist of a cellular device/phone that receives media content via a cellular network.

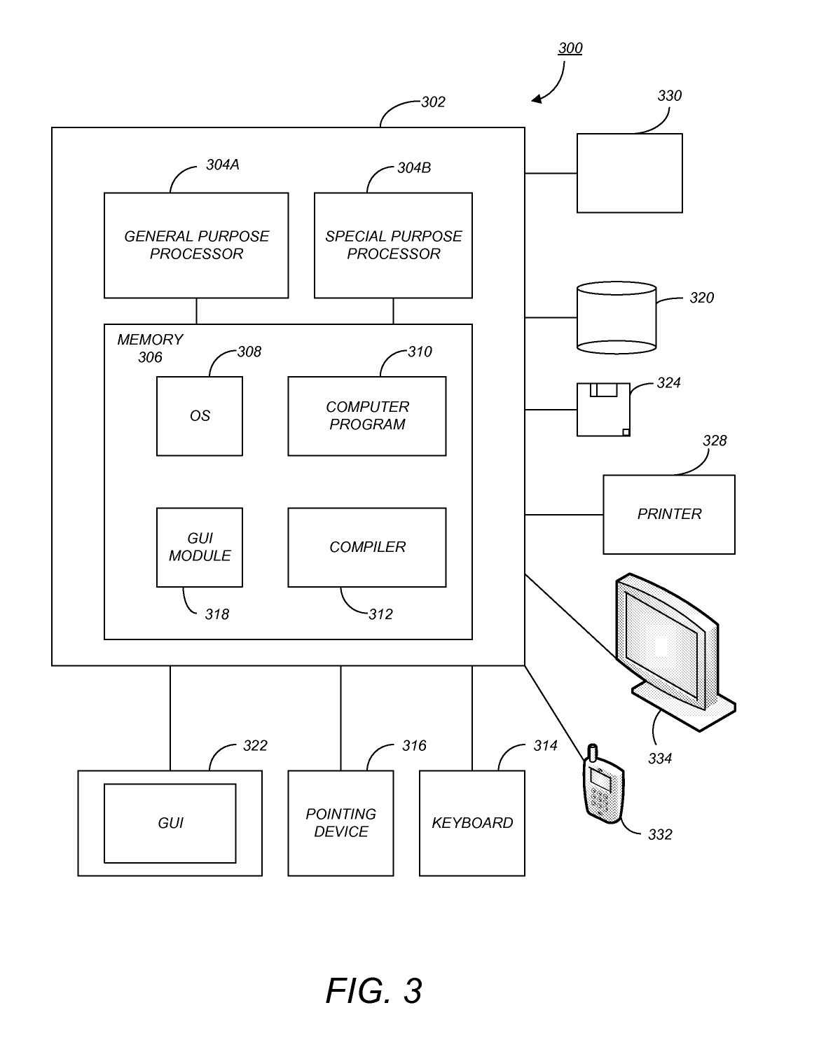

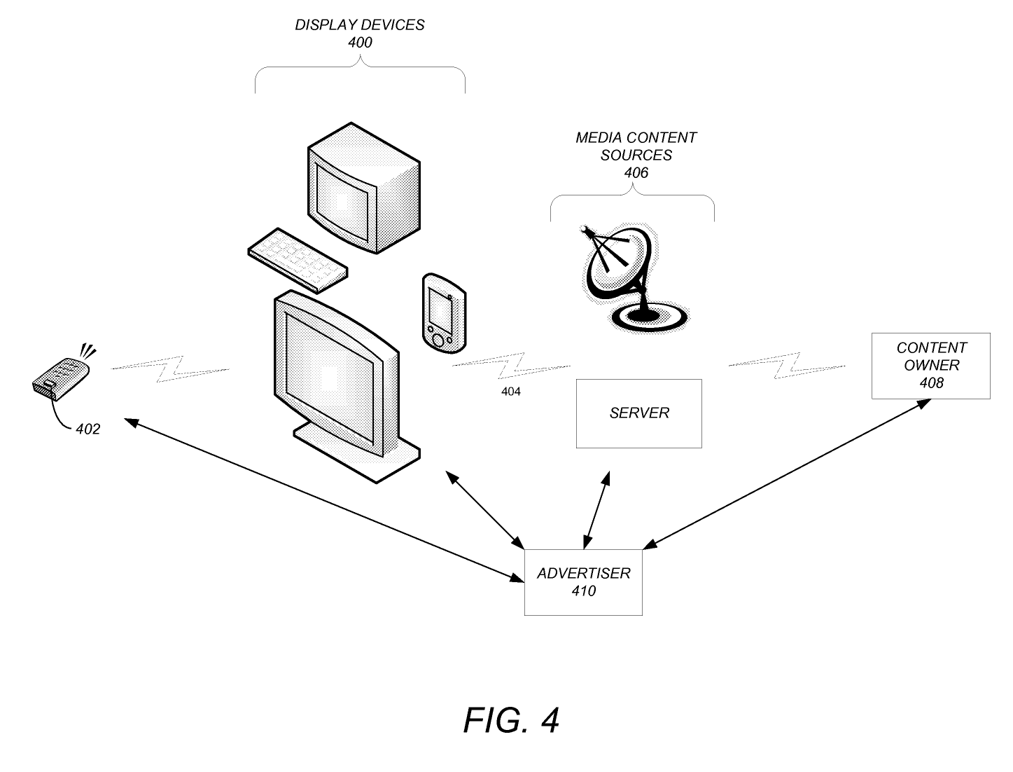

Regardless of the display device utilized, the common component across all such display devices is each display device is configured to display/playback/deliver media content, advertisements, and/or augmentation data to a user. While embodiments of the invention may be utilized in a variety of contexts and hardware platforms, as described above, exemplary platforms are illustrated in FIGS. 3 and 4.

FIG. 3 is an exemplary hardware and software environment/platform 300 used to implement one or more embodiments of the invention. The hardware and software environment includes a computer 302 and may include peripherals. Computer 302 may be a user/client computer, server computer, or may be a database computer. The computer 302 comprises a general purpose hardware processor 304A and/or a special purpose hardware processor 304B (hereinafter alternatively collectively referred to as processor 304) and a memory 306, such as random access memory (RAM). The computer 302 may be coupled to, and/or integrated with, other devices, including input/output (I/O) devices such as a keyboard 314, a cursor control device 316 (e.g., a mouse, a pointing device, pen and tablet, touch screen, multi-touch device, etc.) and a printer 328.

In one or more embodiments, computer 302 may be coupled to, or may comprise, a portable or media viewing/listening device 332 (e.g., an MP3 player, iPod™, Nook™, portable digital video player, cellular device, personal digital assistant, etc.). In yet another embodiment, the computer 302 may comprise a multi-touch device, mobile phone, gaming system, internet enabled television 334, television set top box, or other internet enabled device 334 executing on various platforms and operating systems.

In one embodiment, the computer 302 operates by the general purpose processor 304A performing instructions defined by the computer program 310 under control of an operating system 308. The computer program 310 and/or the operating system 308 may be stored in the memory 306 and may interface with the user and/or other devices to accept input and commands and, based on such input and commands and the instructions defined by the computer program 310 and operating system 308, to provide output and results.

Output/results may be presented on the display 322 or provided to another device (e.g., device 334) for presentation or further processing or action. In one embodiment, the display 322/334 comprises a liquid crystal display (LCD) having a plurality of separately addressable liquid crystals. Alternatively, the display 322/334 may comprise a light emitting diode (LED) display having clusters of red, green and blue diodes driven together to form full-color pixels. Each liquid crystal or pixel of the display 322/334 changes to an opaque or translucent state to form a part of the image on the display in response to the data or information generated by the processor 304 from the application of the instructions of the computer program 310 and/or operating system 308 to the input and commands. The image may be provided through a graphical user interface (GUI) module 318. Although the GUI module 318 is depicted as a separate module, the instructions performing the GUI functions can be resident or distributed in the operating system 308, the computer program 310, or implemented with special purpose memory and processors.

In one or more embodiments, the display 322/334 is integrated with/into the computer 302 and comprises a multi-touch device having a touch sensing surface (e.g., track pod or touch screen) with the ability to recognize the presence of two or more points of contact with the surface. Examples of multi-touch devices include mobile devices (e.g., iPhone™, Nexus S™, Droid™ devices, etc.), tablet computers (e.g., iPad™, HP Touchpad™), portable/handheld game/music/video player/console devices (e.g., iPod Touch™, MP3 players, Nintendo 3DS™, PlayStation Portable™, etc.), touch tables, and walls (e.g., where an image is projected through acrylic and/or glass, and the image is then backlit with LEDs). Alternatively, display 322/334 may consist of a television display device that has a built in tuner/receiver or is connected to a set-top-box configured to receive media content.

Some or all of the operations performed by the computer 302 according to the computer program 310 instructions may be implemented in a special purpose processor 304B. In this embodiment, the some or all of the computer program 310 instructions may be implemented via firmware instructions stored in a read only memory (ROM), a programmable read only memory (PROM) or flash memory within the special purpose processor 304B or in memory 306. The special purpose processor 304B may also be hardwired through circuit design to perform some or all of the operations to implement the present invention. Further, the special purpose processor 304B may be a hybrid processor, which includes dedicated circuitry for performing a subset of functions, and other circuits for performing more general functions such as responding to computer program 310 instructions. In one embodiment, the special purpose processor is an application specific integrated circuit (ASIC).

The computer 302 may also implement a compiler 312 that allows an application or computer program 310 written in a programming language such as COBOL, Pascal, C++, FORTRAN, or other language to be translated into processor 304 readable code. Alternatively, the compiler 312 may be an interpreter that executes instructions/source code directly, translates source code into an intermediate representation that is executed, or that executes stored precompiled code. Such source code may be written in a variety of programming languages such as Java™, Perl™, Basic™, etc. After completion, the application or computer program 310 accesses and manipulates data accepted from I/O devices and stored in the memory 306 of the computer 302 using the relationships and logic that were generated using the compiler 312.

The computer 302 also optionally comprises an external communication device such as a modem, satellite link, Ethernet card, or other device for accepting input from, and/or providing output to, other computers 302.

In one embodiment, instructions implementing the operating system 308, the computer program 310, and the compiler 312 are tangibly embodied in a non-transient computer-readable medium, e.g., data storage device 320, which could include one or more fixed or removable data storage devices, such as a zip drive, floppy disc drive 324, hard drive, CD-ROM drive, tape drive, etc. Further, the operating system 308 and the computer program 310 are comprised of computer program 310 instructions which, when accessed, read and executed by the computer 302, cause the computer 302 to perform the steps necessary to implement and/or use the present invention or to load the program of instructions into a memory, thus creating a special purpose data structure causing the computer 302 to operate as a specially programmed computer executing the method steps described herein. Computer program 310 and/or operating instructions may also be tangibly embodied in memory 306 and/or data communications devices 330, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 302.

FIG. 4 illustrates the interaction between different components of a system/platform of embodiments of the invention. As illustrated, display devices 400 are used to display the media content. Such display devices 400 include cellular devices, television monitors, computers, computer monitors, etc.

The display devices 400 receive the media content across network 404 from media content sources 406. Network 404 may consist of a cellular network, satellite network, broadband network, or any type of network capable of transmitting media content. Such media content sources 406 may include broadcasters (e.g., one of the broadcast networks), media content providers (e.g., a cable provider such as Comcast™, satellite provider such as DirecTV™, etc.), computers (e.g., a server or other computer connected to display devices 400 and/or configured to receive content and deliver such content to display devices 400). Further, such computers may be configured to utilize a media player (e.g., Windows™ Media Player™, Quicktime™, etc.) to display media content on a display device 400.

Media content sources 406 may receive such content from content owners 408 (e.g., movie/television studios, private individuals, record companies, etc.).

Advertisements (and/or augmented functionality) that are displayed/presented in accordance with embodiments of the invention may be received from advertiser 410. Advertiser 410 may communicate/transmit advertisements/augmented functionality to any of the entities involved (e.g., content owner 408, media content sources 406, and/or display devices 400). As used herein, an advertiser may be an actual advertiser, an advertising network (e.g., Specific Media), an advertising exchange, an advertising server, or any system or combination of systems that delivers an advertising creative to another system or device. In yet another embodiment, remote control 402 may also have display capabilities, and advertisements may be displayed on remote control 402 as well.

When advertiser 410 communicates with media content sources 406, the advertiser 410 may negotiate with media content sources 406 to determine the cost, length of time, etc. for placement of an advertisement/augmented functionality. Thereafter, the advertisement/augmented functionality may be inserted by media content sources 406 into the media content. Alternatively, a placeholder may be specified in the media content with the advertisement/augmented functionality delivered to display devices 400 for delivery to the user/consumer. Consequently, advertisements/augmented functionality may be integrated into the media content or may be delivered separately from such media content. Further, in different embodiments, each component (e.g., the content owner 408, media content sources 406, and/or display devices 400) may have the ability to control the advertisement/augmented functionality that is displayed/delivered to a user/consumer.

### Conclusion

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention. Further, embodiments of the present invention contemplates alternative mechanisms for associating augmentation data with an advertisement, such as inserting a unique marker into an advertisement, and comparison of such a unique marker with a copy stored in a database and associated with augmentation data for a specific advertisement. In addition, as described above, any type of playback device is contemplated for receiving the broadcast stream and for communicating with the identification server, including without limitation, televisions, set top boxes and computers.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method of augmenting linear broadcast advertisement, comprising:
broadcasting an advertisement in a linear broadcast stream;
detecting said advertisement by a device receiving said broadcast, wherein upon detection, said device communicates with an identification server to retrieve an augmentation associated with said advertisement; and
presenting said augmentation during broadcast of said advertisement.

2. The method of claim 1, wherein the advertisement has at least one marker indicating augmented functionality in a portion thereof.

3. The method of claim 2, wherein said marker is a generic marker provided in an audio stream of an audio/visual advertisement.

4. The method of claim 2, wherein said marker is a generic marker provided in a video stream of an audio/visual advertisement.

5. The method of claim 2, further comprising generating a fingerprint of a portion of said advertisement with said device after detection of said marker.

6. The method of claim 1, further comprising generating a fingerprint of a portion of said advertisement with said device on a continuous basis.

7. The method of claim 1, further comprising:
generating a fingerprint of a potion of said advertisement with said device; and
providing said fingerprint to said identification server.

8. The method of claim 7, further comprising comparison of said generated fingerprint with a stored fingerprint of said advertisement at said identification server, wherein said stored fingerprint is associated with augmentation data for said advertisement.

9. The method of claim 1, further comprising:
generating a fingerprint of a potion of said advertisement with said device; and
comparing said generated fingerprint with a stored fingerprint of said advertisement locally at said device, wherein said stored fingerprint is associated with augmentation data for said advertisement.

10. The method of claim 9, further comprising the device requesting, from the identification server, augmentation data associated with said advertisement.

11. The method of claim 1, wherein said augmentation is presented along with said advertisement.

12. The method of claim 1, wherein said augmentation comprises a display of additional graphics and information alongside or overlaid on top of an advertisement.

13. The method of claim 1, wherein said augmentation comprises allowing interactivity with a viewer of the advertisement.

14. The method of claim 1, wherein said augmentation comprises causing augmented functionality to be displayed on another device.

15. The method of claim 1, further comprising obtaining statistics on a number of viewers that left an advertisement by changing channels.

16. The method of claim 1, further comprising discerning a number of viewers that interacted with the augmentation.

17. A system for augmenting linear broadcast advertisement, comprising:
broadcasting equipment configured to broadcast an advertisement in a linear broadcast stream;
a device for receiving said broadcast stream, said device configured to detect said advertisement, wherein upon detection, said device is configured to communicate with an identification server to retrieve an augmentation associated with said advertisement; and
wherein said device is configured to present said augmentation during broadcast of said advertisement.

18. A system in accordance with claim 17, wherein the advertisement has at least one marker indicating augmented functionality in a portion thereof.

19. A system in accordance with claim 18, wherein said marker is a generic marker provided in an audio stream of an audio/visual advertisement.

20. A system in accordance with claim 18, wherein said marker is a generic marker provided in a video stream of an audio/visual advertisement.

21. A system in accordance with claim 17, wherein said device is configured to generate a fingerprint of a portion of said advertisement with said device after detection of said marker.

22. A system in accordance with claim 17, wherein said device is configured to generate a fingerprint of a portion of said advertisement with said device on a continuous basis.

23. A system in accordance with claim 17, wherein said device is configured to:
generate a fingerprint of a portion of said advertisement with said device; and
communicate said fingerprint to said identification server.

24. A system in accordance with claim 23, wherein said identification server is configured to compare said generated fingerprint with a stored fingerprint of said advertisement at said identification server, wherein said stored fingerprint is associated with augmentation data for said advertisement.

25. A system in accordance with claim 23, wherein said device is configured to compare said generated fingerprint with a stored fingerprint of said advertisement locally at said device, wherein said stored fingerprint is associated with augmentation data for said advertisement.

26. A system in accordance with claim 25, wherein said device is further configured to make a request, from the identification server, for augmentation data associated with said advertisement.

27. A system in accordance with claim 17, wherein said device is configured to present said augmentation along with said advertisement.

28. A system in accordance with claim 17, wherein said augmentation comprises a display of additional graphics and information alongside or overlaid on top of an advertisement.

29. A system in accordance with claim 17, wherein said augmentation comprises allowing interactivity with a viewer of the advertisement.

30. A system in accordance with claim 17, wherein said augmentation comprises causing augmented functionality to be displayed on another device.

31. A system in accordance with claim 17, said device or identification is configured to obtain statistics on a number of viewers that left an advertisement by changing channels.

32. A system in accordance with claim 17, said device or identification is configured to discern a number of viewers that interacted with the augmentation.
